(19) United States
(12) Patent Application Publication
(10) Pub. No.: US 2017/0057355 A1
(43) Pub. Date: Mar. 2, 2017

(54) VEHICLE SPEED CONTROL SYSTEM

(71) Applicant: TOYOTA JIDOSHA KABUSHIKI KAISHA, Toyota-shi (JP)

(72) Inventors: Yoshitaka OIKAWA, Toyota-shi (JP); Shin TANAKA, Susono-shi (JP); Edgar Yoshio MORALES TERAOKA, Susono-shi (JP)

(73) Assignee: TOYOTA JIDOSHA KABUSHIKI KAISHA, Toyota-shi (JP)

(21) Appl. No.: 15/216,336

(22) Filed: Jul. 21, 2016

(30) Foreign Application Priority Data
Aug. 25, 2015 (JP) 2015-166068

(51) Int. Cl. B60K 31/00; B60W 30/14; B60W 40/072

(52) U.S. Cl. CPC B60K 31/0066; B60W 40/072; B60W 30/146; B60W 2550/22; B60W 2550/146; B60W 2420/42; B60W 2720/106

(57) ABSTRACT

A vehicle speed control system includes a speed limit obtaining unit that obtains a speed limit for a road in front of a vehicle, a curve information obtaining unit that detects a curve on the road, and calculates a distance from a current position of the vehicle to a start position of the curve and a radius of curvature of the curve, a calculating unit that calculates a first maximum speed at which the vehicle does not deviate from a traveling lane on the curve, based on the radius of curvature, and a control unit that controls the vehicle such that a speed of the vehicle at the start position becomes substantially equal to the first maximum speed, when the first maximum speed does not exceed the speed limit.

### INCORPORATION BY REFERENCE

The disclosure of Japanese Patent Application No. 2015-166068 filed on Aug. 25, 2015 including the specification, drawings and abstract is incorporated herein by reference in its entirety.

### BACKGROUND OF THE INVENTION

1. Field of the Invention

The invention relates to a system that performs driving support when a vehicle travels along a curve, for example, and in particular to a system that controls the vehicle speed before the vehicle enters the curve.

2. Description of Related Art

As one example of this type of system, a system has been proposed which obtains information on a radius of curvature of a curve, calculates a permissible speed at which the vehicle is permitted to travel along the curve, from the radius of curvature, and gives warning to a vehicle driver when the speed of the vehicle exceeds the permissible speed (see Japanese Patent Application Publication No. 07-266919 (JP 07-266919 A)).

However, according to the related art as described above, a speed limit for the road on which the vehicle is traveling is not taken into consideration when the permissible speed is calculated; therefore, the vehicle may enter the curve at a speed that exceeds the speed limit.

### SUMMARY OF THE INVENTION

The invention provides a vehicle speed control system that enables a vehicle to enter a curve at an appropriate speed, while keeping a speed limit for a road on which the vehicle is traveling.

A vehicle speed control system according to a first aspect of the invention includes a speed limit obtaining unit that obtains a speed limit for a road in front of a vehicle, a curve information obtaining unit that detects a curve on the road, and calculates a distance from a current position of the vehicle to a start position of the curve and a radius of curvature of the curve, a calculating unit that calculates a first maximum speed at which the vehicle does not deviate from a traveling lane on the curve, based on the radius of curvature, and a control unit that controls the vehicle such that a speed of the vehicle at the start position becomes substantially equal to the first maximum speed, when the first maximum speed does not exceed the speed limit.

According to the vehicle speed control system of the invention, if there is a curve in front of the vehicle, the curve information obtaining unit detects the curve, and calculates the distance to the start position of the curve and the radius of curvature of the curve. At the same time as or before or after this operation, the speed limit obtaining unit obtains the speed limit.

The “speed limit obtaining unit” according to the invention obtains the speed limit from a road sign installed at a road side, an overpass, or the like, in an image captured by a vehicle-mounted camera, for example, through image recognition, or the like. In another example, the speed limit obtaining unit may obtain the speed limit from a road-surface sign or mark drawn on a road surface, in the captured image. In another example, the speed limit obtaining unit may obtain the speed limit from the outside of the vehicle, such as a center that gathers traffic information (which will be called “center” when appropriate), or may obtain the speed limit via road-to-vehicle communications or vehicle-to-vehicle communications, for example.

The “curve information obtaining unit” according to the invention determines the presence or absence of a curve in front of the vehicle, in an image captured by a vehicle-mounted camera, for example, through image recognition, or the like. Further, the curve information obtaining unit detects the start position of the curve in the captured image two or more times while the vehicle is moving, and calculates the distance to the start position. Further, the curve information obtaining unit may create a track of a center line of a lane on which the vehicle is traveling, from right and left white lines or a center line of the lane, in the image captured by the vehicle-mounted camera, for example, and calculate the radius of curvature from the track of the center line. In another example, the curve information obtaining unit may obtain the start position of the curve and the radius of curvature of the curve, from a map database installed on the vehicle. The “start position of the curve” mentioned herein may denote a position at which the calculated radius of curvature becomes equal to or larger than zero, or equal to or larger than a given value.

The calculating unit calculates the first maximum speed, based on the thus calculated radius of curvature. Under control of the control unit, when the calculated first maximum speed does not exceed the speed limit, the speed of the vehicle at the start position is controlled to the calculated first maximum speed. The statement that “controlled to the first maximum speed” means that the vehicle speed is made close to the first maximum speed, or, ideally, is made exactly equal to the first maximum speed, or substantially equal to the first maximum speed (in practice, the vehicle speed is made close to or equal to the first maximum speed, to the extent that the vehicle does not deviate from the traveling lane).

Thus, in this case, when the vehicle enters the curve, the speed is controlled toward the first maximum speed (typically, the vehicle is appropriately decelerated), so that the vehicle does not deviate from the traveling lane. Conversely, when the calculated first maximum speed exceeds the obtained speed limit, the speed of the vehicle is not controlled to the calculated maximum speed, under control of the control unit.

According to the above aspect of the invention, the vehicle speed control system that enables the vehicle to enter a curve at an appropriate speed while keeping the speed limit for a road on which the vehicle is traveling can be provided.

The calculating unit may further calculate a second maximum speed at which the vehicle does not deviate from the traveling lane, based on a friction circle associated with the vehicle and the control unit may control the vehicle such that the speed at the start position becomes substantially equal to a lower one of the first maximum speed and the second maximum speed, in place of the first maximum speed, when the lower one does not exceed the speed limit.

In the system as described above, the control unit does not simply control the speed in the manner as described above when the first maximum speed does not exceed the speed limit, but controls the speed in the manner as described above when the lower one of the second maximum speed calculated by a method different from the method of calculating the first maximum speed, and the first maximum speed, does not exceed the speed limit. Namely, when the vehicle is highly likely to observe the speed limit, the speed is controlled as described above, even if the first maximum speed and the second maximum speed are calculated more or less inaccurately due to influences of errors in the respective speeds. Therefore, the vehicle is able to enter the curve at a safer speed, while keeping the speed limit for the road on which the vehicle is traveling, with higher reliability.

In the above aspect of the invention, the control unit may control the vehicle such that the speed at the start position becomes substantially equal to the speed limit, when the calculated first maximum speed exceeds the speed limit.

In the system as described above, the control unit may set the calculated first maximum speed as a target speed when the calculated first maximum speed does not exceed the speed limit, and set the speed limit as the target speed when the calculated first maximum speed exceeds the speed limit. The control unit may be configured to perform feedback control such that the speed of the vehicle at the start position becomes substantially equal to the target speed.

In the system as described above, when the calculated first maximum speed exceeds the speed limit, the vehicle is controlled such that the speed at the start position of the curve is controlled to the speed limit. Namely, when the first maximum speed exceeds the speed limit, the speed of the vehicle is not only kept from being controlled to the calculated first maximum speed, under control of the control unit, but the vehicle is controlled such that the speed of the vehicle is more positively controlled to the speed limit. The statement that “controlled to the speed limit” means that the vehicle speed is made close to the speed limit, or, ideally, is made exactly equal to the speed limit, or substantially equal to the speed limit (in practice, the vehicle speed is made close to or equal to the speed limit, to the extent that the vehicle speed does not exceed the speed limit). Thus, in either case, the vehicle speed at the start position of the curve will not be controlled by the control unit to be equal to or higher than the speed limit against regulations. In particular, in the arrangement in which the control unit performs F/B control (feedback control), the first maximum speed or the speed limit is initially set as a target speed, depending on the case, and the F/B control is then performed such that the speed of the vehicle becomes substantially equal to the target speed; therefore, the above-described effect unique to this invention can be more reliably obtained.

In one form of the vehicle speed control system in which the second maximum speed is further calculated, the control unit controls the vehicle such that the speed at the start position becomes substantially equal to the speed limit, when the lower one of the first maximum speed and the second maximum speed exceeds the speed limit.

In the system as described above, the control unit may set the lower one of the first maximum speed and the second maximum speed as a target speed when the lower one does not exceed the speed limit, and set the speed limit as the target speed when the lower one exceeds the speed limit. The control unit may be configured to perform feedback control such that the speed of the vehicle at the start position becomes substantially equal to the target speed.

In the system as described above, when the lower one of the first maximum speed and the second maximum speed exceeds the speed limit, the vehicle is controlled such that the speed at the start position of the curve becomes substantially equal to the speed limit. Namely, when the lower one exceeds the speed limit, the vehicle is controlled, under control of the control unit, such that the speed of the vehicle is not only kept from being controlled to the lower one, but the speed of the vehicle is more positively controlled to the speed limit. Thus, in either case, the vehicle speed at the start position of the curve will not be controlled by the control unit to be equal to or higher than the speed limit against regulations. In particular, in the arrangement in which the control unit performs F/B control, the lower one or the speed limit is initially set as the target speed, depending on the case, and the F/B control is then performed such that the speed of the vehicle becomes substantially equal to the target speed; therefore, the above-described effect unique to this invention can be more reliably obtained.

In another form of the vehicle speed control system as described above, a camera that captures an image in front of the vehicle is further provided, and the speed limit obtaining unit obtains the speed limit from the captured image, while the curve information obtaining unit calculates the distance and the radius of curvature from the captured image.

According to the above form, the speed limit obtaining unit can obtain the speed limit, through image recognition, character recognition, or the like, from a road sign or a road-surface indication in an image captured by an image capturing unit, such as a vehicle-mounted camera, for example, even if the vehicle is not installed with equipment for obtaining speed limits from a center, or a map database including speed limits. Further, the curve information obtaining unit can detect, from an image captured by the image capturing unit, the start position of the curve in the captured image two or more times while the vehicle is moving, or detect the start position once or two or more times with two or more cameras, and calculate the distance to the start position by a triangulation method, or the like, even if the vehicle is not installed with equipment for obtaining curve information from the center, or a map database including curve information. Further, the curve information obtaining unit can create a track of a center line of the lane on which the vehicle is traveling, from right and left white lines or a center line of the lane, which is/are continuously or intermittently recognized as a line segment or an array of successive dots or points, through image recognition, character recognition, or the like, and calculate the radius of curvature from the track of the center line.

With the above arrangement, the vehicle, which is equipped with the image capturing unit, is able to enter a curve at an appropriate speed, while keeping the speed limit for a road on which the vehicle is traveling.

A vehicle speed control system according to a second aspect of the invention includes an actuator that accelerates or decelerates a vehicle, and an ECU configured to obtain a speed limit for a road in front of the vehicle, determine whether a curve is present on the road, calculate a distance from a position of the vehicle to a start position of the curve and a radius of curvature of the curve, when the curve is present on the road, calculate a first speed based on the radius of curvature, and control the actuator such that a speed of the vehicle at the start position of the curve becomes substantially equal to the first speed, when the first speed does not exceed the first speed.

The above-described effects and other advantages of the invention will be more apparent from the following description of embodiments.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram showing the configuration of a vehicle on which a vehicle speed control system of a first embodiment of the invention is installed;

FIG. 2 is an explanatory view concerning calculation of a first maximum speed;

FIG. 3 is a flowchart illustrating the flow of processing performed by the vehicle speed control system of the first embodiment;

FIG. 4 is a time chart showing one example of the operation of the vehicle speed control system of the first embodiment;

FIG. 5 is a time chart showing another example of the operation of the vehicle speed control system of the first embodiment;

FIG. 6 is a block diagram showing the configuration of a vehicle on which a vehicle speed control system of a second embodiment of the invention is installed;

FIG. 7 is an explanatory view concerning calculation of a second maximum speed; and

FIG. 8 is a flowchart illustrating the flow of processing performed by the vehicle speed control system of the second embodiment.

### DETAILED DESCRIPTION OF EMBODIMENTS

### First Embodiment

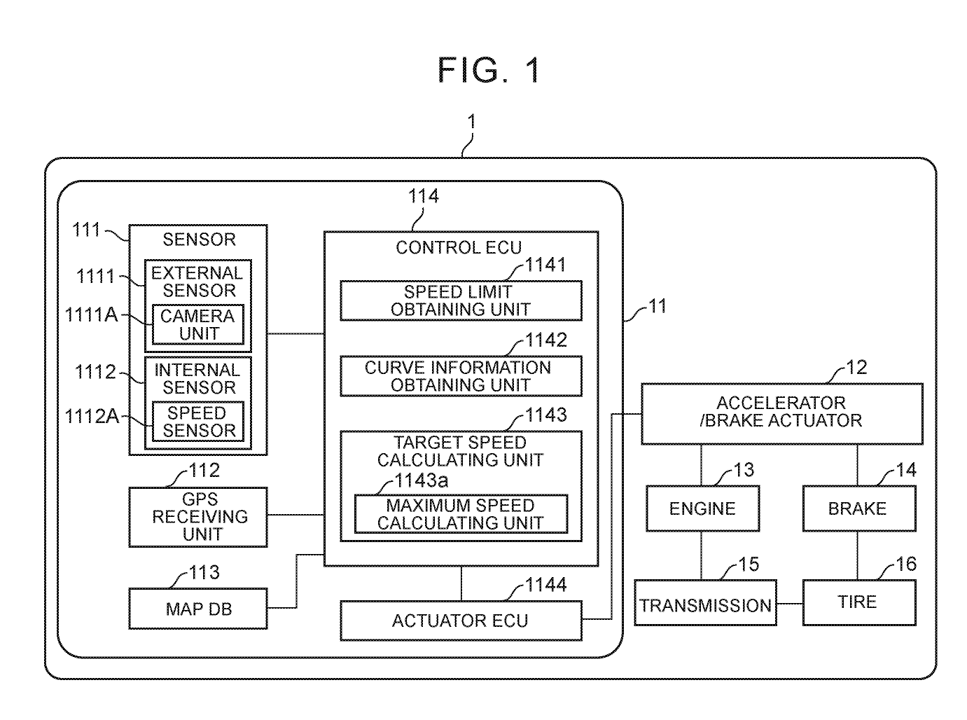

In the following, a vehicle speed control system according to a first embodiment of the invention will be described with reference to FIG. 1 through FIG. 5.

Referring to FIG. 1, one example of the vehicle speed control system of the first embodiment will be described. FIG. 1 is a block diagram showing one example of the configuration of a vehicle on which the vehicle speed control system of the first embodiment is installed.

As shown in FIG. 1, the vehicle 1 includes the vehicle speed control system 11, accelerator/brake actuator 12, engine 13, brake 14, transmission 15, and tires 16.

In order to calculate various signals to be output to the accelerator/brake actuator 12, the vehicle speed control system 11 includes sensors 111, GPS (Global Positioning System) receiving unit 112, map DB (database) 113, control ECU (Electronic Control Unit) 114, and an actuator ECU 1144.

The sensors 111 are detection devices for detecting information necessary or useful for traveling of the vehicle. The detection results of the sensors 111 are transmitted as needed to the control ECU 114. The sensors 111 include external sensors 1111 and internal sensors 1112, for example.

The external sensors 1111 are detection devices for detecting external conditions of the vehicle. The external conditions may include circumstances or surrounding environment of the vehicle, for example.

The external sensors 1111 include a camera unit 1111A that constitutes one specific example of “image capturing unit” according to the invention. The camera unit 1111A is installed on a front glass portion or back mirror portion of the vehicle, for example. Also, the camera unit 1111A captures an image of a lane in front of the vehicle (namely, a lane on which the vehicle is going to travel). The camera unit 1111A may be a monocular camera or a compound-eye camera. Further, two or more cameras may be arranged to be spaced a fixed distance apart from each other.

The internal sensors 1112 are detection devices for detecting internal conditions of the vehicle. The internal conditions may include traveling conditions of the vehicle, for example. The internal conditions may also include operating conditions of various devices of the vehicle.

The internal sensors 1112 include a speed sensor 1112A. The speed sensor 1112A is a detection device that detects the speed of the vehicle. One example of the speed sensor 1112A is a wheel speed sensor. The internal sensors 1112 may further include an acceleration sensor, distance sensor, inclination angle sensor, and so forth.

The GPS receiving unit 112 measures the position of the vehicle (which will be called “vehicle position” when appropriate), by receiving GPS signals from three or more GPS satellites. The GPS receiving unit 112 transmits vehicle position information indicating the measured vehicle position, to the control ECU 114. A measurement device capable of measuring the vehicle position may be provided in addition to or in place of the GPS receiving unit 112. Further, the system may be configured such that the own vehicle position can be specified via road-to-vehicle communications or vehicle-to-vehicle communications.

The map DB 113 is a database that stores map information indicating maps. The map DB 113 is built in a recording medium (such as HDD (Hard Disk Drive)) installed in the vehicle. The map information includes, for example, road position information indicating the positions of roads, intersections, branch points, signals, etc. included in the maps, road shape information indicating the shapes of the roads included in the maps (for example, information indicating road types, such as a curve and a straight line, and information indicating the curvature of each curve), and so forth. The map information may further include building position information indicating the positions of shielding structures, such as buildings and walls. The map information as described above may be downloaded via wireless communications or Internet, for example, and may be updated as needed to the latest one. Further, the map DB may be provided in a center that gathers traffic information (which will be called “center” when appropriate), and map information on a front area of the vehicle 1 may be downloaded sequentially or as needed, via communicating means.

The control ECU 114 receives outputs of the sensors 111, GPS receiving unit 112 and the map DB 113. The control ECU 114 calculates various signals to be output to the actuator ECU 1144. The actuator ECU 1144 calculates various signals to be output to the accelerator/brake actuator 12, under control of the control ECU 114.

In order to calculate various signals to be output to the actuator ECU 1144, the control ECU 114 includes a speed limit obtaining unit 1141 as one specific example of “speed limit obtaining unit” according to the invention, curve information obtaining unit 1142 as one specific example of “curve information obtaining unit” according to the invention, and a target speed calculating unit 1143 as one specific example of “calculating unit” according to the invention, as logical processing blocks or physical processing circuits realized in the ECU 114. The actuator ECU 1144, which constitutes one specific example of “control unit” according to the invention, is configured to calculate various signals to be output to the accelerator/brake actuator 12, so as to control the accelerator/brake actuator 12. In the vehicle speed control system 11 of this embodiment, the actuator ECU 1144 is provided separately from the control ECU 114; however, the actuator ECU 1144 may be incorporated in the control ECU 114.

The speed limit obtaining unit 1141, which consists of a processor, a memory, etc., obtains a speed limit on a lane on which the vehicle 1 is going to travel. For example, the speed limit obtaining unit 1141 may obtain the speed limit from a road sign installed at a road side, an overpass, or the like, in an image captured by a vehicle-mounted camera as the camera unit 1111A. In another example, the speed limit obtaining unit 1141 may obtain the speed limit from a road-surface sign or mark drawn on a road surface, in an image captured by the camera unit 1111A, for example. In another example, the speed limit obtaining unit 1141 may obtain the speed limit from the outside of the vehicle, such as a center. For example, the speed limit obtaining unit 1141 may obtain the speed limit via road-to-vehicle communications or vehicle-to-vehicle communications. The captured image may be transmitted from the vehicle 1 to the center, where image recognition, or the like, may be conducted. In other words, at least a part of the speed limit obtaining unit 1141 may be provided at the outside of the vehicle 1 to which it is connected via communicating means. The speed limit may be obtained at regular intervals irrespective of the presence or absence of a curve, or may be obtained irregularly, as in the case where there is a curve, for example.

The curve information obtaining unit 1142, which consists of a processor, a memory, etc., detects a curve located in front of the vehicle 1 through image recognition, or the like, in an image captured by the camera unit 1111A. Further, the curve information obtaining unit 1142 detects the start position of the curve in the captured image two or more times while the vehicle is moving, and calculates a distance to the start position. Further, the curve information obtaining unit 1142 creates a track of a center line of a lane on which the vehicle 1 is traveling, from right and left white lines or a center line of the lane, in the image captured by the camera unit 1111A, for example, and calculates the radius of curvature from the track of the center line. In another example, the curve information obtaining unit 1142 may obtain the start position of the curve and the radius of curvature of the curve, from the map DB 113 installed on the vehicle, or may obtain them from the map DB located in the center, or may obtain them via road-to-vehicle communications or vehicle-to-vehicle communications. The captured image may be transmitted from the vehicle 1 to the center, and the radius of curvature, etc. may be calculated at the center. In other words, at least a part of the curve information obtaining unit 1142 may be provided at the outside of the vehicle 1 to which it is connected via communication means. The “start position of the curve” mentioned herein may denote a position at which the calculated radius of curvature becomes equal to or larger than zero, or equal to or larger than a given value.

The target speed calculating unit 1143 consists of a processor, a memory, etc., and includes a maximum speed calculating unit 1143a that calculates a first maximum speed, based on the radius of curvature obtained by the curve information obtaining unit 1142. Then, the first maximum speed is compared with the speed limit obtained by the speed limit obtaining unit 1141, and the first maximum speed is set as a target speed when the first maximum speed is equal to or lower than the speed limit. The target speed determined in this manner is set as a target speed used for F/B control in the actuator ECU 1144.

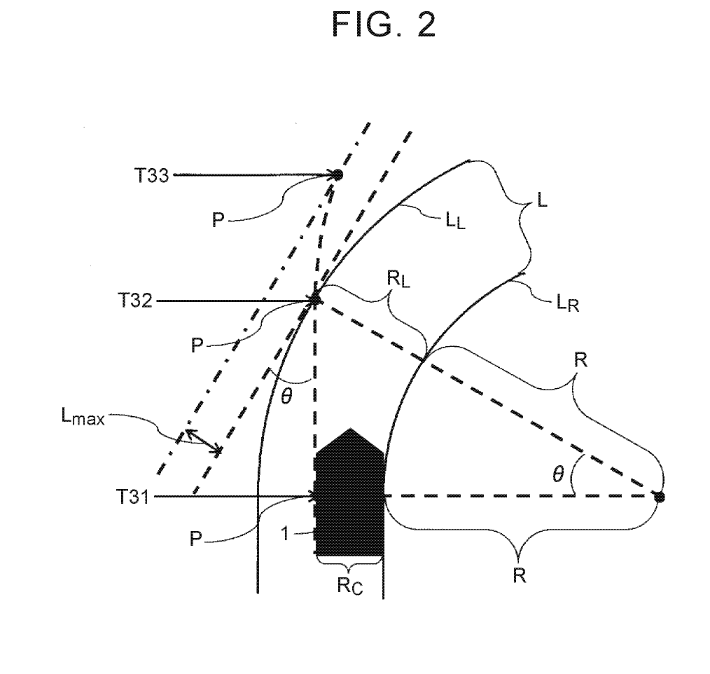

Here, a method of calculating the first maximum speed will be described with reference to FIG. 2. FIG. 2 shows the case where the maximum speed Vmax1 is obtained when the vehicle 1 enters a curve having a radius of curvature R, along a lane L having a lane width R_{L}. The target speed calculating unit 1143 creates a plane view as shown in FIG. 2, from map information of the map DB 113, and curve information obtained by the curve information obtaining unit 1142. Then, the vehicle 1 (i.e., own vehicle) having a width of R_{C} is plotted in the plane view such that it is located at the curve start position, and the right-hand side face of the vehicle 1 overlaps a right white line L_{R} of the lane L. Where a point in time at which the curve is detected is set as zero, T31 denotes a period up to the time when a point P on the left-hand side face of the vehicle 1 reaches the start position of the curve, T32 denotes a period up to the time when the point P starts deviating from the lane L, and T33 denotes a period up to the time when the point P reaches the maximum deviation position, a deviation entry angle θ is obtained according to the following equation.

$$cos θ = \frac{R + {R}_{C}}{R + {R}_{L}} \qquad ( 1 )$$

Then, assuming that there is no difference between the speed V(t31) at the time when the point P reaches the start position of the curve, and the speed V(t32) at the time when the point P starts deviating (namely, V(t31)=V(t32)), the period T32 can be expressed as follows, using the period T31.

$$T 32 = T 31 + \frac{( R + {R}_{L} ) sin θ}{V ( t 31 )} \qquad ( 2 )$$

Also, where G_{C} denotes a limit lateral acceleration applied to the vehicle 1, a distance L(t) between the point P and the left white line L_{L} can be expressed as follows.

L(t)=0+∫_{T31}^{T32}V(t31)sin θdt+∫_{T32}^{T33}{G_{C}(t−T32)−V(t32)sin θ}dt (3)

Also, where a direction in which the point P moves away from the right white line L_{L} is negative, the negative maximum value Lmax of L(t) is determined by a differential; therefore, T33 can be expressed as follows, using T32, if a differential of the above equation (3) is set to zero.

$$T 33 = T 32 + \frac{V ( t 32 ) sin θ}{{G}_{C}} \qquad ( 4 )$$

Here, if Eq. (2) indicated above is substituted into Eq. (4) indicated above, T33 can be expressed as follows, using T31.

$$T 33 = T 31 + \frac{( R + {R}_{L} ) sin θ}{V ( t 31 )} + \frac{V ( t 32 ) sin θ}{{G}_{C}} \qquad ( 5 )$$

Then, if Eq. (2) and Eq. (5) are substituted into Eq. (3), the negative maximum value Lmax of L(t) can be expressed as follows.

$${L}_{max} = ( R + {R}_{L} ) {sin}^{2} θ - \frac{{V}^{2} ( t 32 ) {sin}^{2} θ}{2 {G}_{C}} \qquad ( 6 )$$

If Eq. (6) above is solved with respect to V(t32), the following equation (7) will be obtained.

$$V ( t 32 ) = \frac{\sqrt{2 {G}_{C} \{ ( R + {R}_{L} ) {sin}^{2} θ - {L}_{max} \}}}{sin θ} \qquad ( 7 )$$

Here, the first maximum speed Vmax1 may be V(t32) of Eq. (7). Also, the first maximum speed Vmax may be obtained, in view of a safety margin, by multiplying V(t32) of Eq. (7) by a safety margin coefficient or adding or subtracting the safety margin coefficient to or from V(t32) of Eq. (7). For example, when the road surface is in a good condition, and the vehicle is unlikely to slip, the first maximum speed Vmax1 may be equal to V(t32) of Eq. (7). On the other hand, when the vehicle 1 is likely to slip because of rain or snow, for example, the first maximum speed Vmax1 may be obtained by multiplying V(t32) of Eq. (7) by a safety margin coefficient or adding or subtracting the safety margin coefficient to or from V(t32).

The calculation of the first maximum speed has been explained above.

Referring back to FIG. 1, the actuator ECU 1144 compares the target speed calculated by the target speed calculating unit 1143 with the current vehicle speed detected by the speed sensor 1112A. If the target speed and the current vehicle speed are not equal to each other, the actuator ECU 1144 calculates the throttle opening or the brake hydraulic pressure, which is needed for accelerating or decelerating the vehicle from the current vehicle speed to the target speed, by the time when the vehicle reaches the start position of the curve obtained by the curve information obtaining unit 1142. Namely, in this case, the actuator ECU 1144 controls the vehicle speed to the target speed in a feedback manner, via the accelerator/brake actuator 12.

The accelerator/brake actuator 12 adjusts the throttle opening, based on the output from the actuator ECU 1144, so as to control the amount of air flowing into the engine 13. Also, the accelerator/brake actuator 12 adjusts the brake hydraulic pressure, based on the output from the actuator ECU 1144, so as to control braking force applied to the vehicle 1. In the case where the vehicle 1 is a hybrid vehicle, the accelerator/brake actuator 12 may control the output of a motor-generator.

The engine 13 is a mechanism that produces power for the vehicle 1, and may be, for example, a gasoline engine or a diesel engine. The brake 14 is a mechanism that produces braking force to be applied to the vehicle 1, and may consist of a brake caliper, brake pad, and so forth. In the case of a hybrid vehicle, the brake 14 includes a mechanism that adjusts the voltage of electric power generated by a motor-generator.

The transmission 15 is a mechanism that transmits the output of the engine 13 to the tires 16.

One example of the structure of the vehicle 1 on which the vehicle speed control system 11 of the first embodiment is installed has been explained above.

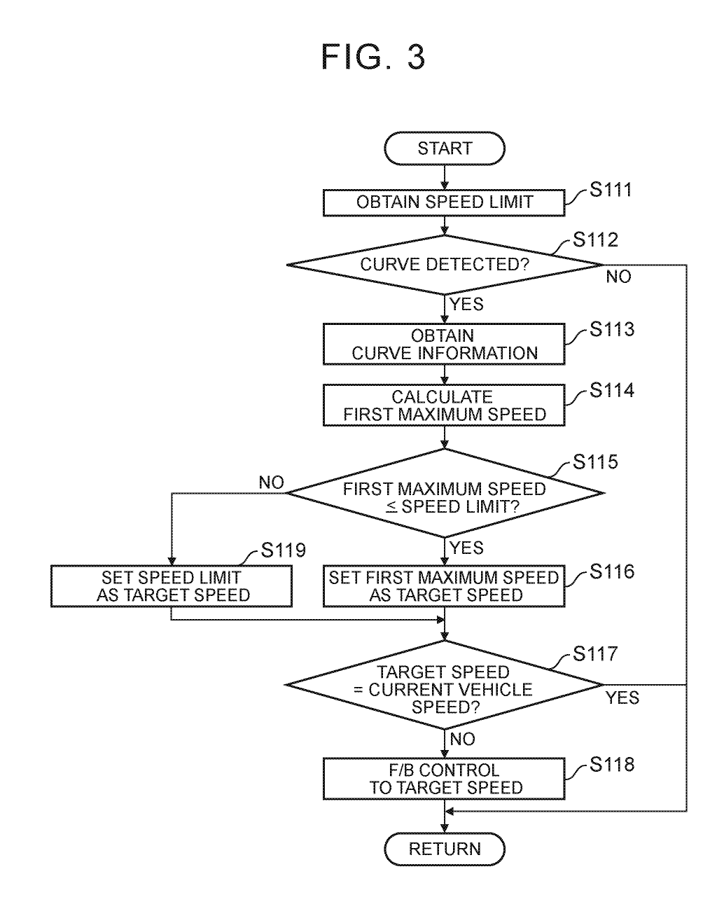

Referring next to the flowchart of FIG. 3, a control routine performed by the vehicle speed control system 11 of the first embodiment will be described.

As shown in FIG. 3, the speed limit obtaining unit 1141 obtains speed limit information, from an image captured by the camera unit 1111A (step S111). Then, the curve information obtaining unit 1142 determines whether a curve can be detected in front of the vehicle, depending on the presence or absence of a curve in front of the vehicle, from the image captured by the camera unit 1111A (step S112). If no curve is detected, as a result of determination in step S112 (step S112: NO), the vehicle speed control system 11 finishes this cycle of the routine shown in FIG. 3. The order of execution of step S111 and step S112 is not necessarily the same as the order indicated in the flowchart of FIG. 3. Namely, step S112 may be executed earlier, or step S111 and step S112 may be executed at the same time.

On the other hand, if a curve is detected as a result of determination in step S112 (step S112: YES), the curve information obtaining unit 1142 calculates the start position of the curve, and the radius of curvature of the curve, from the image captured by the camera unit 1111A (step S113). Then, the maximum speed calculating unit 1143a included in the target speed calculating unit 1143 calculates the first maximum speed, based on the radius of curvature of the curve calculated by the curve information obtaining unit 1142 (step S114).

Then, the target speed calculating unit 1143 determines whether the calculated first maximum speed is equal to or lower than the speed limit obtained by the speed limit obtaining unit 1141 (step S115). If the first maximum speed is higher than the speed limit, as a result of determined in step S115 (step S115: NO), the target speed calculating unit 1143 sets the speed limit as the target speed (step S119). On the other hand, if the first maximum speed is equal to or lower than the speed limit, as a result of determination in step S115 (step S115: YES), the target speed calculating unit 1143 sets the first maximum speed as the target speed (step S116).

Subsequently, the actuator ECU 1144 determines whether the target speed set by the target speed calculating unit 1143 coincides with the current vehicle speed (step S117). It may be determined that the target speed “coincides with” the current vehicle speed even if these speeds do not completely or perfectly coincide with each other. For example, the actuator ECU 1144 may determine that the target speed coincides with the current vehicle speed if the current vehicle speed is within a range of 5 km/h above and below the target speed. If it is determined in step S117 that the target speed coincides with the current vehicle speed (step S117: YES), the vehicle speed control system 11 finishes the routine shown in FIG. 3.

On the other hand, if it is determined in step S117 that the target speed does not coincide with the current vehicle speed (step S117: NO), the actuator ECU 1144 calculates the throttle opening or the brake hydraulic pressure, which is needed for accelerating or decelerating the vehicle from the current vehicle speed to the target speed, by the time when the vehicle reaches the start position of the curve obtained by the curve information obtaining unit 1142. Then, a signal indicative of the calculated throttle opening or brake hydraulic pressure is output to the accelerator/brake actuator 12. Namely, the actuator ECU 1144 controls the vehicle speed to the target speed in a feedback manner, via the accelerator/brake actuator 12 (step S118).

In the above-described manner, the control routine performed by the vehicle speed control system 11 of the first embodiment ends. The routine shown in FIG. 3 returns to “START” once it goes to “RETURN”. Then, the routine shown in FIG. 3 is repeatedly executed as a sub-routine processing during traveling of the vehicle 1 (about several dozens to several thousands of times per second, for example).

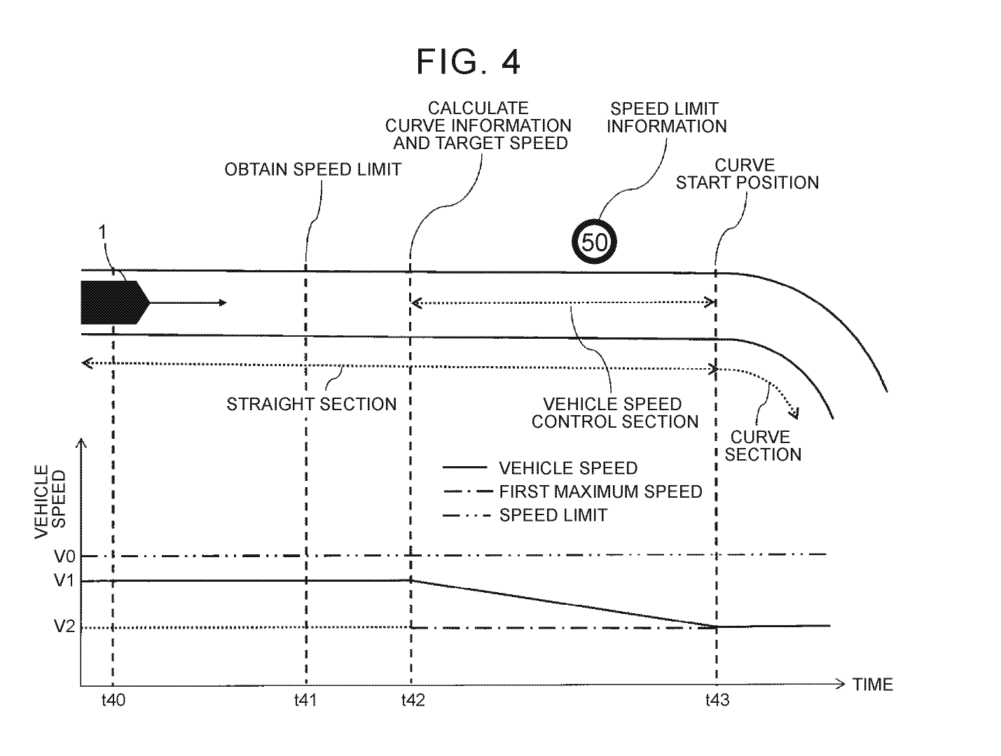

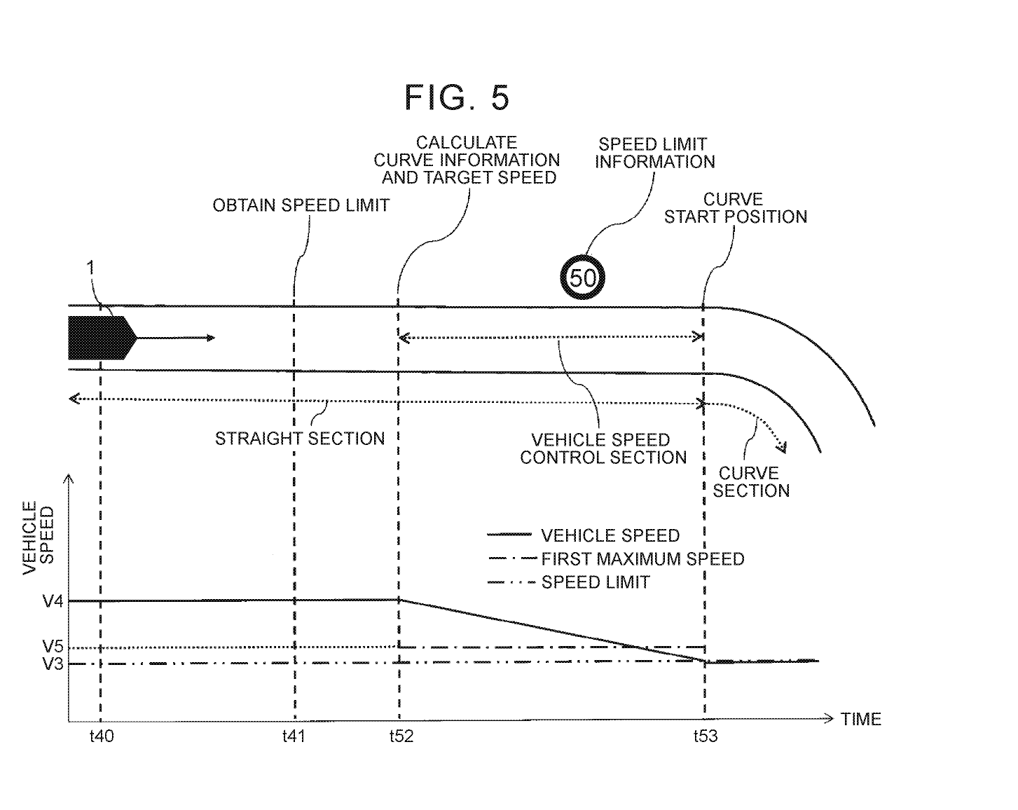

Referring next to FIG. 4 and FIG. 5, one example of the operation of the vehicle speed control system 11 of the first embodiment will be described along with movement of the vehicle.

As shown in FIG. 4, the vehicle 1 travels in a straight section at a speed V1, toward a curve section (time t40). Then, the vehicle 1 obtains a speed limit V0 from a road sign installed at a road side, based on an image captured by the camera unit 111A (time t41).

Then, the following operation is performed at time t42. Initially, the vehicle 1 detects a curve, from the image captured by the camera unit 1111A, and calculates curve information including the start position of the curve and the radius of curvature of the curve (see step S113 of FIG. 3). Then, the vehicle 1 calculates the first maximum speed V2 (see step S114 of FIG. 3). Subsequently, the vehicle 1 determines that the first maximum speed V2 is equal to or lower than the speed limit V0 (see step S115 of FIG. 3), and further determines that the first maximum speed V2 is not equal to the speed limit V0 (see step S117 of FIG. 3). Finally, the vehicle 1 sets the first maximum speed V2 as the target speed, and starts vehicle speed control (see step S118 of FIG. 3). In the operation as described above, a given length of time is needed from detection of the curve to the time when the vehicle speed control is started; however, the given length of time is short since the above calculations are actually performed in the control ECU 114. Therefore, the above-described operation is assumed to be performed at time 42.

Subsequently, between time t42 and time t43, the speed of the vehicle 1 is reduced down to V2 by the time when the vehicle 1 reaches the start position of the curve. Then, the vehicle 1 enters the curve section at the speed V2 (time t43).

One example of the operation of the vehicle speed control system 11 of the first embodiment has been described above with reference to FIG. 4. Then, another example of the operation of the vehicle speed control system 11 of the first embodiment will be described with reference to FIG. 5. In FIG. 5, a part of the operation is different from that of FIG. 4 as described above, but there are many similar or common portions in the remaining part of the operation. Therefore, only a portion of the example of FIG. 5 which is different from that of FIG. 4 as already described above will be described in detail, and description of overlapping portions will be omitted as appropriate.

As shown in FIG. 5, the vehicle 1 travels in a straight section at a speed V4, toward a curve section (time t40). At time t52, the following operation is performed. Initially, the vehicle 1 detects a curve, from an image captured by the camera unit 1111A, and calculates curve information including the start position of the curve and the radius of curvature of the curve (see step S113 of FIG. 3). Then, the vehicle 1 calculates the first maximum speed V5 (see step S114 of FIG. 3). Subsequently, the vehicle 1 determines that the first maximum speed V5 is higher than the speed limit V3 (see step S115 of FIG. 3), and further determines that the speed limit V3 is not equal to the current vehicle speed V4 (see step S117 of FIG. 3). Finally, the vehicle 1 sets the speed limit V3 as the target speed, and starts the vehicle speed control (see step S118 of FIG. 3). While a given length of time is needed from detection of the curve to the time when the vehicle speed control is started, the given length of time is short since the above operation, such as calculations, is actually performed in the control ECU 114 and the actuator ECU 1144. Therefore, the above-described process is assumed to be carried out at time 52.

Subsequently, between time t52 and time t53, the speed of the vehicle 1 is reduced down to V3 by the time when the vehicle 1 reaches the start position of the curve. Then, the vehicle 1 enters the curve section at the speed V3 (time t53).

The other example of the operation of the vehicle speed control system 11 of the first embodiment as shown in FIG. 5 has been described above.

According to the vehicle speed control system 11 of the first embodiment, the vehicle 1 can be controlled so that it can enter a curve at an appropriate speed, while keeping the speed limit for the road on which the vehicle 1 is traveling. Also, when the first maximum speed exceeds the speed limit, the vehicle 1 is controlled so that the speed at the start position of the curve becomes equal to the speed limit. Namely, when the first maximum speed exceeds the speed limit, the speed of the vehicle 1 is not only kept from being made equal to the calculated first maximum speed, but the speed of the vehicle 1 is more positively made equal to the speed limit, under control of the control ECU 114 and the actuator ECU 1144. Thus, in either case, the vehicle speed at the start position of the curve will not be made equal to or higher than the speed limit against regulations, under control of the control ECU 114 and the actuator ECU 1144. Further, the speed limit obtaining unit 1141 and the curve information obtaining unit 1142 can obtain the speed limit information and the curve information, from the image captured by the camera unit 111A, even if the vehicle 1 is not installed with equipment for obtaining information from the center, or a map DB (see MAP DB 113 in FIG. 1) including the speed limit and curve information. Thus, if the vehicle 1 is equipped with an image capturing unit, such as the camera unit 1111A, the vehicle 1 can enter a curve at an appropriate speed, while keeping the speed limit for the road on which the vehicle 1 is traveling. The “image capturing unit” as described above may be provided in the vehicle 1 as the own vehicle, or may be provided in a front vehicle with which the vehicle 1 is connected via vehicle-to-vehicle communications, or may be provided on a road with which the vehicle 1 is connected via road-to-vehicle communications.

### Second Embodiment

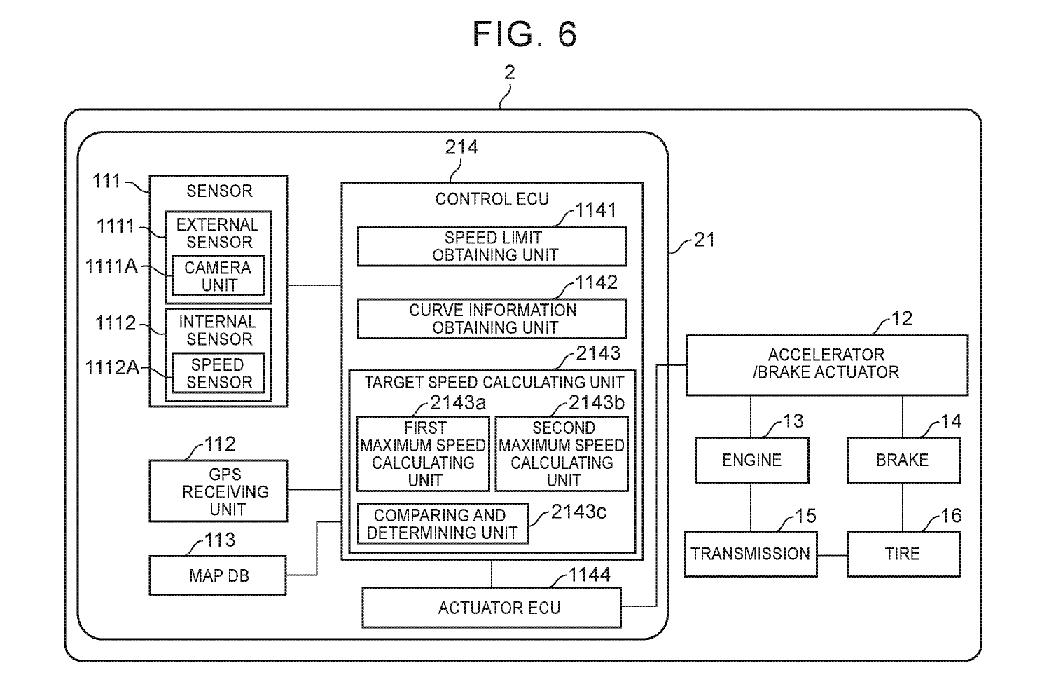

Referring next to FIG. 6 through FIG. 8, a vehicle speed control system according to a second embodiment of the invention will be described. While a part of the operation is different between the second embodiment and the first embodiment as described above, there are many similar or common portions in the remaining part of the operation. Therefore, only a portion of the second embodiment which is different from that of the first embodiment as already described above will be described in detail, and description of overlapping portions will be omitted as appropriate.

One example of the vehicle speed control system of the second embodiment will be described. FIG. 6 is a block diagram showing one example of the configuration of a vehicle on which the vehicle speed control system of the second embodiment is installed.

The vehicle speed control system 21 according to the second embodiment shown in FIG. 6 is installed on the vehicle 2, and is different from that of the first embodiment shown in FIG. 1 in the configuration of a control ECU 214, more specifically, in the configuration of a target speed calculating unit 2143 as one specific example of “calculating unit” according to the invention. The other configuration according to the second embodiment is substantially identical with that of the first embodiment shown in FIG. 1.

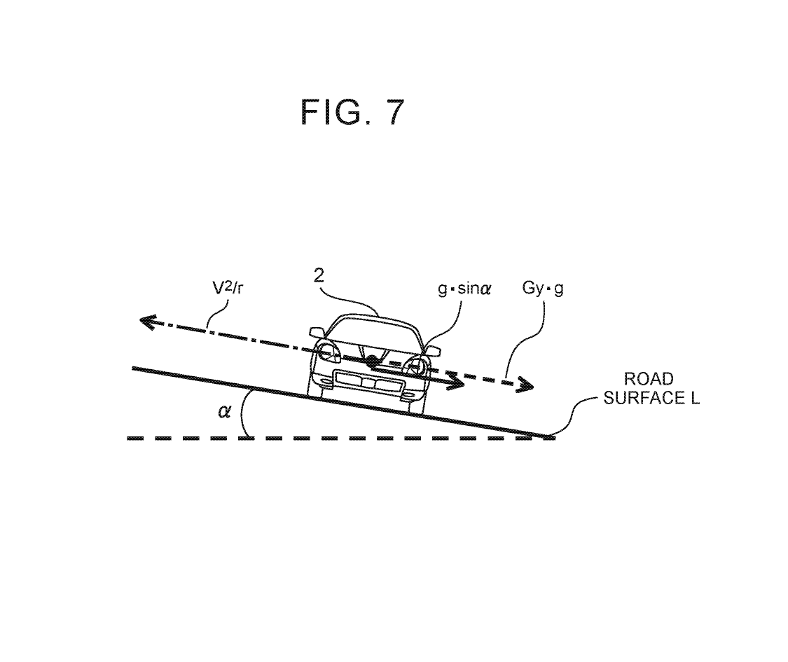

The target speed calculating unit 2143, which consists of a processor, a memory, etc., for example, calculates a first maximum speed and a second maximum speed, based on the radius of curvature obtained by the curve information obtaining unit 1142. More specifically, a first maximum speed calculating unit 2143a calculates the first maximum speed in the same manner as in the case of the above-described first embodiment (see FIGS. 2, 4 and 5), and a second maximum speed calculating unit 2143b calculates the second maximum speed in a manner as described below (see FIG. 7, etc.). A comparing and determining unit 2143c compares the first maximum speed with the second maximum speed, and selects or determines the lower one of these speeds. Further, the target speed calculating unit 2143 compares the lower one thus determined, with the speed limit obtained by the speed limit obtaining unit 1141, and sets the lower one as the target speed when the lower one is equal to or lower than the speed limit. Conversely, if the lower one exceeds the speed limit, the speed limit is set as the target speed.

A method of calculating the second maximum speed will be described with reference to FIG. 7. The method of calculating the first maximum speed is the same as that of the first embodiment, and therefore, will not be described herein.

The second maximum speed is calculated using a friction circle. For example, as shown in FIG. 7, the vehicle 2 is traveling on a cant (or bank) road having a radius of curvature R and a degree of inclination α without changing its lateral position. The radius of curvature R is calculated as needed by the curve information obtaining unit 1142 (see FIG. 6). The inclination a is obtained as needed from an inclination angle sensor included in the internal sensors 1112, or from an image captured by the camera unit 1111A. In this case, force N which the vehicle 2 applies to a road surface L in the vertical direction is mg·cos α. Accordingly, the maximum radius of the friction circle (namely, the maximum acceleration applied to the vehicle 2) is obtained by multiplying the force N in the vertical direction by a coefficient μ that depends on each vehicle, and is expressed as μ·N. Namely, the longitudinal acceleration Gfr applied to the vehicle, and the lateral acceleration Grl applied to the vehicle need to satisfy the following expression.

Grl²+Gfr²≦(μN)² (8)

Then, where V represents the speed of the vehicle 2, and g represents the gravitational acceleration, the centrifugal acceleration applied to the vehicle 2 needs to satisfy the following equation so that the lateral position of the vehicle is kept unchanged. The speed V is obtained as needed from the speed sensor 1112A (see FIG. 6), and the gravitational acceleration g is obtained as a preset or known value.

$$\frac{V}{R} = ( Grl + sin α ) g \qquad ( 9 )$$

In order to obtain the speed (i.e., the second maximum speed) when the vehicle turns a curve, using the friction circle to the limit, the above expression (8) in which the inequality sign is changed to an equality sign, and Gfr is set to zero, is substituted into the above equation (9). As a result, the second maximum speed Vmax2 can be expressed as follows.

V max 2={square root over ((\sqrt{(μN)²}+sin α)gR)} (10)

The second maximum speed Vmax2 may also be obtained, in view of a safety margin, by multiplying a safety margin coefficient by the result of Eq. (10), or adding or subtracting the safety margin coefficient to or from the result of Eq. (10). For example, when the road surface is in a good condition, and the vehicle 2 is unlikely to slip, the second maximum speed Vmax2 may be equal to the result of Eq. (10). On the other hand, when the vehicle 2 is likely to slip because of rain or snow, for example, the second maximum speed Vmax2 may be obtained by multiplying the safety margin coefficient by the result of Eq. (10) or adding or subtracting the safety margin coefficient to or from the result of Eq. (10).

The calculation of the second maximum speed has been explained above.

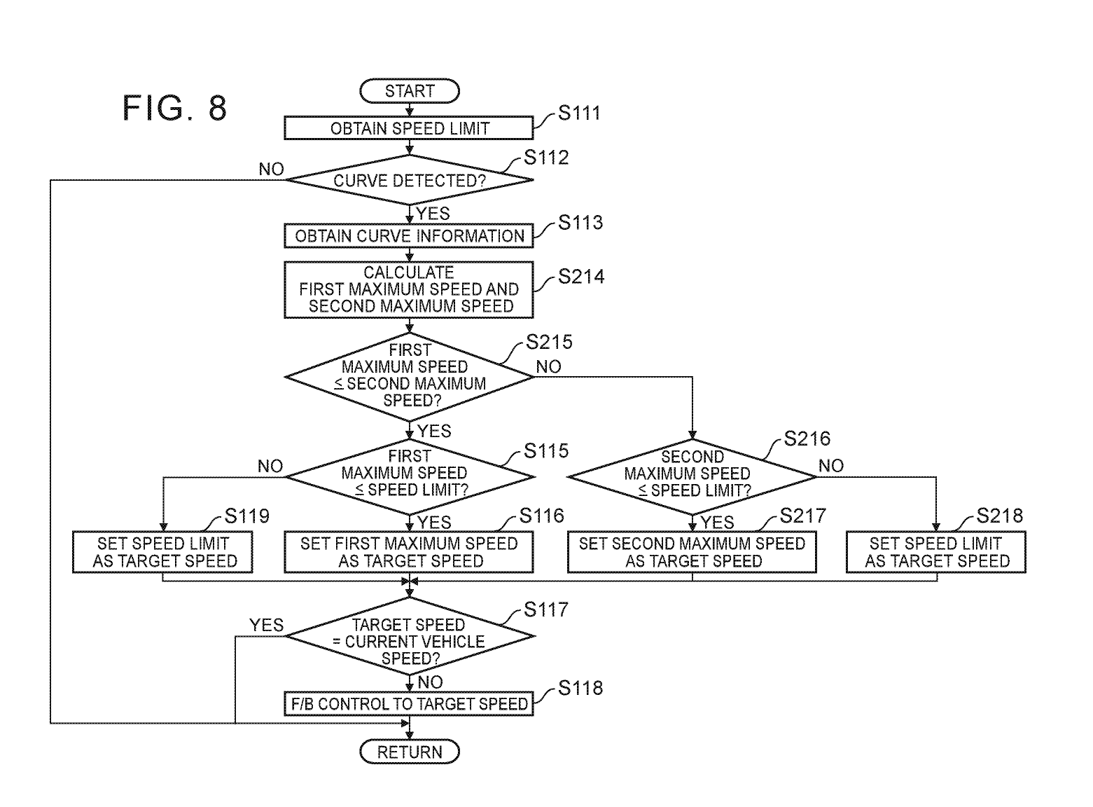

Referring next to the flowchart of FIG. 8, a control routine performed by the vehicle speed control system of the second embodiment will be described. In FIG. 8, the same reference numerals are assigned to the same steps as those of the flowchart of FIG. 3 according to the first embodiment, and explanation of these steps will be omitted as appropriate.

As shown in FIG. 8, the control routine of the second embodiment is identical with that of the first embodiment until the curve information obtaining unit 1142 obtains curve information (step S113). Then, the first maximum speed calculating unit 2143a and the second maximum speed calculating unit 2143b of the target speed calculating unit 2143 calculate the first maximum speed and the second maximum speed, respectively (step S214). Subsequently, the comparing and determining unit 2143c of the target speed calculating unit 2143 determines whether the first maximum speed is equal to or lower than the second maximum speed (step S215). If the first maximum speed is equal to or lower than the second maximum speed, as a result of determination in step S215 (step S215: YES), the control proceeds to step S115.

On the other hand, if the first maximum speed is higher than the second maximum speed, as a result of determination in step S215 (step S215: NO), the target speed calculating unit 2143 determines whether the second maximum speed is equal to or lower than the speed limit obtained by the speed limit obtaining unit 1141 (step S216). If the second maximum speed is higher than the speed limit, as a result of determination in step S216 (step S216: NO), the target speed calculating unit 2143 sets the speed limit as the target speed (step S218). On the other hand, if the second maximum speed is equal to or lower than the speed limit, as a result of determination in step S216 (step S216: YES), the target speed calculating unit 2143 sets the second maximum speed as the target speed (step S217).

In the manner as described above, the control routine performed by the vehicle speed control system 21 of the second embodiment ends.

According to the vehicle speed control system of the second embodiment, the vehicle speed control is not simply performed in the same manner as in the first embodiment when the first maximum speed does not exceed the speed limit, but the vehicle speed control is performed when the lower one of the first maximum speed and the second maximum speed calculated according to a method different from the method of calculating the first maximum speed does not exceed the speed limit. Namely, when the speed limit is highly likely to be observed, the speed is controlled in the manner as described above, even if the first maximum speed and the second maximum speed are calculated more or less inaccurately due to influences of errors in the respective speeds. Therefore, the vehicle 2 is able to enter a curve at a safer speed, while keeping the speed limit for the road on which the vehicle 2 is traveling, with higher reliability.

This invention can be changed or modified as needed, without departing from the principle or concept of the invention which can be read from the appended claims and the description as a whole, and vehicle speed control systems involving such changes are also included in the technical concept of the invention.

What is claimed is:

1. A vehicle speed control system comprising:
a speed limit obtaining unit that obtains a speed limit for a road in front of a vehicle;
a curve information obtaining unit that detects a curve on the road, and calculates a distance from a current position of the vehicle to a start position of the curve and a radius of curvature of the curve;
a calculating unit that calculates a first maximum speed at which the vehicle does not deviate from a traveling lane on the curve, based on the radius of curvature; and
a control unit that controls the vehicle such that a speed of the vehicle at the start position becomes substantially equal to the first maximum speed, when the first maximum speed does not exceed the speed limit.

2. The vehicle speed control system according to claim 1, wherein:
the calculating unit further calculates a second maximum speed at which the vehicle does not deviate from the traveling lane, based on a friction circle associated with the vehicle; and
the control unit controls the vehicle such that the speed at the start position becomes substantially equal to a lower one of the first maximum speed and the second maximum speed, in place of the first maximum speed, when the lower one does not exceed the speed limit.

3. The vehicle speed control system according to claim 1, wherein
the control unit controls the vehicle such that the speed at the start position becomes substantially equal to the speed limit, when the calculated first maximum speed exceeds the speed limit.

4. The vehicle speed control system according to claim 3, wherein
the control unit sets the calculated first maximum speed as a target speed when the calculated first maximum speed does not exceed the speed limit, and sets the speed limit as the target speed when the calculated first maximum speed exceeds the speed limit, the control unit performing feedback control such that the speed of the vehicle at the start position becomes substantially equal to the target speed.

5. The vehicle speed control system according to claim 2, wherein
the control unit controls the vehicle such that the speed at the start position becomes substantially equal to the speed limit, when the lower one of the first maximum speed and the second maximum speed exceeds the speed limit.

6. The vehicle speed control system according to claim 5, wherein
the control unit sets the lower one of the first maximum speed and the second maximum speed as a target speed when the lower one does not exceed the speed limit, and sets the speed limit as the target speed when the lower one exceeds the speed limit, the control unit performing feedback control such that the speed of the vehicle at the start position becomes substantially equal to the target speed.

7. The vehicle speed control system according to claim 1, further comprising an image capturing unit that captures an image in front of the vehicle, wherein
the speed limit obtaining unit obtains the speed limit from the captured image, and the curve information obtaining unit calculates the distance and the radius of curvature from the captured image.

8. A vehicle speed control system comprising:
an actuator that accelerates or decelerates a vehicle; and
an ECU configured to
obtain a speed limit for a road in front of the vehicle,
determine whether a curve is present on the road,
calculate a distance from a position of the vehicle to a start position of the curve and a radius of curvature of the curve, when the curve is present on the road,
calculate a first speed based on the radius of curvature, and
control the actuator such that a speed of the vehicle at the start position of the curve becomes substantially equal to the first speed, when the first speed does not exceed the first speed.
